(19) United States
(12) Patent Application Publication
(10) Pub. No.: US 2011/0068096 A1
(43) Pub. Date: Mar. 24, 2011

(54) Heater

(75) Inventors: Kuohsun LIN, Ren Teh Hsiang (TW); Chunjie HONG, Xiamen (CN)

(73) Assignee: TSANN KUEN (CHINA) ENTERPRISE CO., LTD., Fujian (CN)

(21) Appl. No.: 12/203,937

(22) Filed: Sep. 4, 2008

(30) Foreign Application Priority Data
Sep. 4, 2007 (CN) 200720008161.0

(51) Int. Cl. H05B 3/40; B67D 7/82

(52) U.S. Cl. 219/534; 222/146.5

(57) ABSTRACT

A heater comprises a cast casing, a heating tube and a water tube coiled on the heating tube imbedded in the cast, wherein the heating tube is U-shaped and has two electric terminals for connecting to the power, and the water tube has an inlet and an outlet extending out of the casting. Because the heating tube and water tube are imbedded in the casting, and there are fillings that fully fill the interstice between the heating tube and the water tube, the casting has good heat accumulation ability, which allows the heat generated by the heating tube to be highly concentrated to achieve high heat transfer efficiency.

### FIELD OF THE INVENTION

The present invention relates to a heater.

### BACKGROUND OF THE INVENTION

Traditional heaters comprise a base board, a heating tube and a water tube, the base board has a groove for containing the heating tube and the water tube. When power is provided to the heating tube, heat will be transferred from the heating tube to the water tube by way of thermal conduction to heat up the water in the water tube. Because of the interstice which affects the heating-conduction efficiency among the heating tube, the water tube and the groove, these heaters have high heating wastage and requires long heating time.

In order to remedy the above mentioned deficiency, a solution has been provided in Chinese patent No. 200520065015.2, entitled “An electric heater for coffee maker,” and published on Oct. 11, 2006. The electric heater disclosed herein includes a casting used as a base, a heating tube and a water tube, the heating tube and the water tube being embedded in the casting, and the heating tube twisted in a spiral, the water tube coiled on the heating tube, the heating tube and the water tube inter-twist to form a spiral. The heating tube and the water tube are twisted to a cross spiral; however the structure of the heating tube and the water tube is highly complex, and has high manufacturing cost.

### SUMMARY OF THE INVENTION

An object of the present invention is to provide a heater which obviates the disadvantages of the complex structure, inconvenient manufacture and high manufacture cost of the heaters of the prior art.

The above and other objects of the invention are achieved by providing a heater comprising a casting, a heating tube and a water tube coiled on the heating tube imbedded in the casting, wherein the heating tube is U-shaped and has two electric terminals for connecting to the power, and the water tube has an inlet and an outlet extending out of the casting,

According to one preferred embodiment of the present invention, the heater further comprises a pump body connecting to the water inlet.

According to one preferred embodiment of the present invention, the water tube is twisted to an S-shape.

According to another preferred embodiment of the present invention, the water tube twisted to a waveform.

According to another preferred embodiment of the present invention, the water tube is twisted to a clip-shape.

According to another preferred embodiment of the present invention, the water tube includes multiple S-shaped sections, which are serially connected.

According to another preferred embodiment of the present invention, the water tube is twisted on the upper and lower sides of the heating tube.

According to another preferred embodiment of the present invention, the inlet and the outlet of the water tube are mounted on the same side of the casting.

According to another preferred embodiment of the present invention, the inlet and the outlet of the water tube are mounted on the two opposite sides of the casting respectively.

According to another preferred embodiment of the present invention, the heater is used in a coffee maker.

According to another preferred embodiment of the present invention, the heater is used in water dispenser.

In the heater provided in the present invention, the heating tube and water tube are imbedded in the casting, and there are fully-filled fillings between the interstice between the heating tube and the water tube. Thus the casting has good heat accumulation ability, which makes the heat generated by the heating tube more concentrated resulting in higher heat transfer efficiency. This allows the provision of real-time hot water or rapid and continuous steam with high efficiency, and prevents excessive heat consumption, and achieving the object of energy-saving. In addition, because the heating tube is U-shaped, the overall heater structure is simple and easy to manufacture at lower cost. Further, because the water tube of the heater provided in the present invention is S-shaped, awhile the heating tube is U-shaped, the simple-structured heating tube thus works with the S-shape water tube to prolong the transfer distance of the water tube in a small space, and to that ensure the water has sufficient heating-absorption time.

### BRIEF DESCRIPTION OF THE DRAWINGS

Some preferred embodiments of the present invention will be described in detail with reference to the drawings and examples.

FIG. 1 is a perspective view of the heater in one preferred embodiment of the present invention.

FIG. 2 is an explode view of the heater in one preferred embodiment of the present invention.

FIG. 3 is a sectional view of the heater in one preferred embodiment of the present invention.

FIG. 4 is an exploded view of the heater in another embodiment of the present invention.

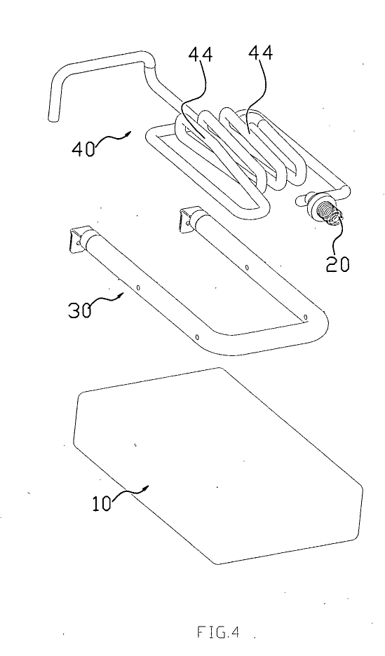

FIG. 5 is a sectional view of the heater in another embodiment of the present invention.

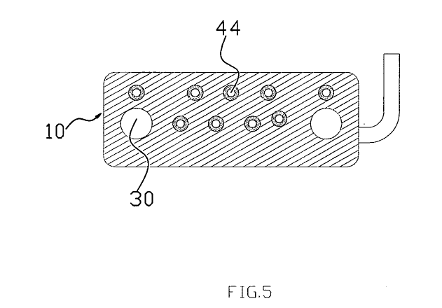

Legends: casting 10, pump body 20, heating tube 30, water tube 40, upper portion of the S-shape section 41, lower portion of the S-shape section 42, middle portion of the S-shape section 43, clip-shape section 44.

### DETAILED DESCRIPTION OF THE INVENTION

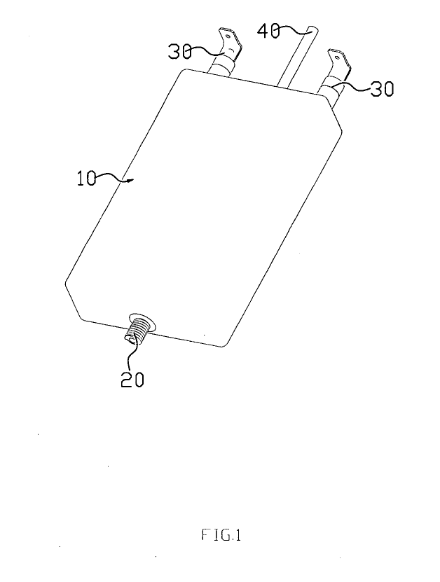

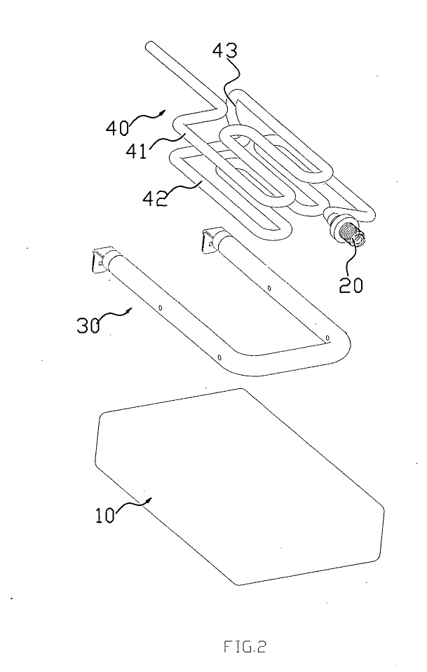

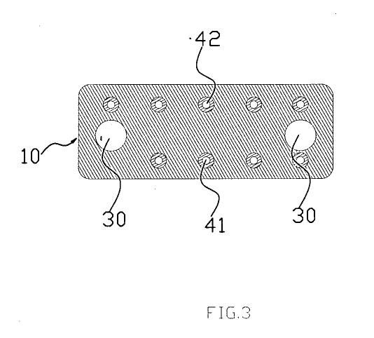

FIG. 1, FIG. 2 and FIG. 3, are the perspective view, exploded view and sectional view, respectively, of the heater in one preferred embodiment of the present invention respectively. The heater comprises a casting 10 and a pump body 20, wherein the casting 10 has a heating tube 30 embedded inside and a water tube 40 twisted around the outside of the heating tube 30. The Heater of the present invention can be used in coffee makers, but without limitation, it can also be used in other facilities such as water dispenser.

The heating tube 30 is U-shaped and has two electric connection terminals for connecting to power, the two terminals extending out of the same side of the casting 10.

The water tube 40 has an inlet and an outlet extending out of the casting 10, wherein the inlet and outlet extend out the opposite sides of the casting 10 respectively. The pump body 20 is connected to the water inlet for providing continual water. The water tube 40 includes a serially-connected upper portion of the S-shape section 41, lower portion of the S-shape section 42 and middle portion of the S-shape section 43, the heating tube 30 is mounted between the upper portion of the S-shape section 41 and the lower portion of the S-shape section 42.

For manufacturing, firstly the heating tube 30 and the S-shape water tube 40 are fixed and placed in the mold as inserts, then melted alloy liquid is poured into the mold to fill full of the interstice among the heating tube and the water tube to form casting 10.

In another preferred embodiment, the water tube 40 includes series-connected several un-closed clip-shape of sections 44, wherein the tail of the front section is connected to the head of the back section. The U-shaped heating tube 30 surrounds the water tube 40.

The above-mentioned descriptions are of exemplary embodiments only, and are not intended to limit the scope, applicability or configuration of the invention in any way. All changes that come within the meaning and range of equivalency of the claims are to be embraced within their scope.

What is claimed is:

1. A heater comprising a casting, a heating tube and a water tube coiled on the heating tube imbedded in the casting, wherein the heating tube is U-shaped and has two electric terminals for connecting to the power, and the water tube has an inlet and an outlet extending out the casting.

2. The heater according to claim 1, wherein the water tube is twisted to S-shape.

3. The heater according to claim 1, wherein the water tube is twisted to waveform.

4. The heater according to claim 1, wherein the water tube is twisted to clip-shape.

5. The heater according to claim 1, wherein the water tube includes multiple S-shaped sections, which are serially connected.

6. The heater according to claim 1, wherein the water tube twisted on the upper and lower sides of the heating tube.

7. The heater according to claim 1, wherein said heater further comprises a pump body connecting to the water inlet.

8. The heater according to claim 1, wherein the inlet and the outlet of the water tube mounted are on the same side of the casting.

9. The heater according to claim 1, wherein the inlet and the outlet of the water tube mounted are on the two opposite sides of the casting respectively.

10. The heater according to claim 1 5, wherein the heater is used in a coffee maker.

11. The heater according to claim 1, wherein the heater is used in a water dispenser.

12. A coffee maker comprising a heater of claim 1.

13. A water dispenser comprising a heater of claim 1.
